(19) United States
(12) Patent Application Publication
(10) Pub. No.: US 2026/0322604 A1
(43) Pub. Date: Oct. 15, 2026

(54) Method and Apparatus for Operating a Remote Diagnosis System of a Vehicle

(71) Applicant: Bayerische Motoren Werke Aktiengesellschaft, Muenchen (DE)

(72) Inventors: Michael Reithmeier, Eichenau (DE); Peter Winklhofer, Muenchen (DE)

(21) Appl. No.: 19/483,140

(22) PCT Filed: Mar. 22, 2024
(86) PCT No.: PCT/EP2024/057754

§ 371 Date: Nov. 10, 2025

(30) Foreign Application Priority Data
May 22, 2023 (DE) 10 2023 113 314.4

(51) Int. Cl. H04L 9/30; G07C 5/00; G07C 5/08

(52) U.S. Cl. CPC H04L 9/30; G07C 5/008; G07C 5/0808; G07C 5/0816

(57) ABSTRACT

A method operates a remote diagnosis system of a vehicle, and includes obtaining a remote-diagnosis authorization object for a remote diagnosis server by a mobile terminal using a digital vehicle key. The method also includes signing by the mobile terminal the remote-diagnosis authorization object using a private cryptographic key of the digital vehicle key, and transmitting the signed remote-diagnosis authorization object from the mobile terminal to a verification computing device. The verification computing device is a backend server and/or a first control unit of the vehicle. The method further includes executing a remote diagnosis command on at least one control unit of the vehicle according to the signed remote-diagnosis authorization object if a signature of the signed remote-diagnosis authorization object has been verified successfully on the verification computer device using a public cryptographic key of the digital vehicle key.

The present application is the U.S. national phase of PCT Application PCT/EP2024/057754 filed on Mar. 22, 2024, which claims priority of German patent application No. 10 2023 113 314.4 filed on May 22, 2023, the entire contents of which are incorporated herein by reference.

### TECHNICAL FIELD

The disclosure relates generally to the field of vehicles, and more particularly, remote diagnosis systems of vehicles.

### BACKGROUND

Vehicles that can be accessed by a vehicle manufacturer by means of remote diagnosis are known from the prior art. For this purpose, a user of the vehicle must explicitly allow access by the vehicle manufacturer via an operating interface of the vehicle. Alternatively, a user can activate in a breakdown call via an emergency call system, which is integrated in the vehicle, access to the vehicle by the vehicle manufacturer by means of remote diagnosis. The access by means of remote diagnosis is confined here to the vehicle manufacturer. It is not possible for a user of the vehicle to direct authorization for remote diagnosis to a third-party and/or to the manufacturer of the vehicle.

Accordingly, a need exists to operate a remote diagnosis system of a vehicle more securely. In particular, there is a need to operate a remote diagnosis system of a vehicle more flexibly and more securely.

### SUMMARY

The above-stated needs, as well as others, are addressed by at least some embodiments disclosed herein.

A first aspect is characterized by a method for operating a remote diagnosis system of a vehicle. The method can be a computer-implemented method and/or a method implemented by a control unit. The remote diagnosis system of the vehicle can be a distributed remote diagnosis system of the vehicle. For example, the remote diagnosis system can comprise a mobile terminal of a user of vehicle, a remote diagnosis server, a backend server of a vehicle manufacturer, and/or one or more control units of the vehicle. The vehicle can be a motor vehicle, for example an automobile or a motorcycle. The method comprises obtaining a remote-diagnosis authorization object for a remote diagnosis server by a mobile terminal that has a digital vehicle key, in particular by a mobile terminal on which the digital vehicle key is stored. The obtaining of the remote-diagnosis authorization object can comprise generating the remote-diagnosis authorization object for the remote diagnosis server by the mobile terminal. The mobile terminal can be a smartphone, a smart watch, and/or another smart device that has a digital vehicle key. The digital vehicle key is preferably stored on the mobile terminal. More preferably, the digital vehicle key is stored on a secure element of the mobile terminal. The digital vehicle key can be a standardized digital vehicle key. The digital vehicle key can be standardized according to a standard of the Connected Car Consortium. For example, the digital vehicle key can be a digital vehicle key according to the Digital Key Release 3.x specification of the Connected Car Consortium.

The method comprises signing by the mobile terminal the remote-diagnosis authorization object using a private cryptographic key of the digital vehicle key, and transmitting the signed remote-diagnosis authorization object from the mobile terminal to a backend server of a vehicle manufacturer and/or to a first control unit of the vehicle. In addition, the method can comprise verifying on the backend server of the vehicle manufacturer and/or on the first control unit of the vehicle a signature of the signed remote-diagnosis authorization object using a public cryptographic key of the digital vehicle key. If the signature of the signed remote-diagnosis authorization object has been verified on the backend server of the vehicle manufacturer and/or on the first control unit of the vehicle using the public cryptographic key of the digital vehicle key, the method executes a remote diagnosis command on the first control unit of the vehicle and/or on one or more further control units of the vehicle according to the signed remote-diagnosis authorization object.

Advantageously, the signing of the remote-diagnosis authorization object can efficiently improve the security of remote diagnosis. By signing the remote diagnosis object, the user of the vehicle can authorize remote diagnosis access flexibly and/or more precisely. Hence using the digital vehicle key, the user of the vehicle has a flexible control facility over remote diagnosis accesses. Via remote diagnosis it is possible, for example, to execute securely vehicle functions such as unlocking a vehicle door. By virtue of the flexible control facility using the mobile terminal, the user always has the facility to prevent unauthorized access by means of remote diagnosis by refusing to sign the remote-diagnosis authorization object and/or not granting authorization for the remote diagnosis. In addition, the user can flexibly grant third-parties, for example a vehicle repair shop, remote diagnosis access, so that the third-party can identify and/or rectify a possible error and/or a possible fault in the vehicle. Hence using the digital vehicle key of the mobile terminal, the user has a simple facility for controlling remote diagnosis access by a third-party and/or vehicle manufacturer securely and flexibly.

According to at least some embodiments, the remote-diagnosis authorization object can comprise an authorization object for reading diagnostic data from the first control unit and/or from one or more further control units of the vehicle as a remote diagnosis command. It is thereby possible to execute a plurality of remote diagnosis commands for a multiplicity of control units of the vehicle efficiently using the remote diagnosis object.

According to at least one implementation, the remote-diagnosis authorization object can comprise an authorization object for controlling a remote diagnosis function of the first control unit and/or of one or more further control units of the vehicle as remote diagnosis command. It is thereby possible to execute a plurality of remote diagnosis functions on a multiplicity of control units of the vehicle efficiently using the remote diagnosis object.

In some embodiments, the private cryptographic key of the digital vehicle key can be stored in a secure key memory, also known as a secure element, of the mobile terminal. The security of the signing of the remote diagnosis object can thereby be improved efficiently. According to a further advantageous embodiment, the transmitting of the signed remote-diagnosis authorization object from the mobile terminal to the backend server of the vehicle manufacturer and/or to the first control unit of the vehicle can comprise transmitting the signed remote-diagnosis authorization object from the mobile terminal to the remote diagnosis server, and transmitting the signed remote-diagnosis authorization object from the remote diagnosis server to the backend server of the vehicle manufacturer and/or to the first control unit of the vehicle. By transmitting the transmission of the remote-diagnosis authorization object via the backend server of the vehicle manufacturer to the first control unit of the vehicle, the vehicle manufacturer can verify a remote diagnosis access using the remote-diagnosis authorization object and/or keep a record of remote diagnosis accesses to the vehicle. The security of the remote diagnosis system can thereby be improved efficiently.

In at least one embodiment, the remote diagnosis server can be a remote diagnosis server of the vehicle manufacturer or a remote diagnosis server of a third-party. The method can thereby be adapted flexibly to different remote diagnosis service providers and their remote diagnosis servers. The method can be executed by different remote diagnosis service providers and their remote diagnosis servers.

According to some embodiments, the transmitting of the signed remote-diagnosis authorization object from the remote diagnosis server to the backend server of the vehicle manufacturer can comprise transmitting the signed remote-diagnosis authorization object from the remote diagnosis server to the backend server of the vehicle manufacturer, verifying on the backend server of the vehicle manufacturer the signature of the signed remote-diagnosis authorization object using a public cryptographic key of the digital vehicle key, and transmitting the signed remote-diagnosis authorization object from the backend server of the vehicle manufacturer to the first control unit of the vehicle if the signature of the signed remote-diagnosis authorization object has been verified successfully on the backend server of the vehicle manufacturer using the public cryptographic key of the digital vehicle key. The verification by the backend server can be performed in addition to verification of the signature on the first control unit of the vehicle or as an alternative to the verification of the signature on the first control unit of the vehicle. The backend server of the vehicle manufacturer can thereby verify the signature of the remote-diagnosis authorization object and efficiently improve the security of the remote diagnosis system.

In some implementations, the method can further comprise transmitting an error message from a control unit of the vehicle to the backend server of the vehicle manufacturer, transmitting the error message from the backend server of the vehicle manufacturer to the remote diagnosis server, and/or transmitting the error message from the backend server of the vehicle manufacturer to the mobile terminal, if the signature of the signed remote-diagnosis authorization object has not been verified successfully on the backend server of the vehicle manufacturer using the public cryptographic key of the digital vehicle key. An error status relating to verification of the signature can thereby be transmitted to the remote diagnosis server and/or the mobile terminal.

According to at least one embodiment, the mobile terminal can sign the remote-diagnosis authorization object using a private cryptographic key of the digital vehicle key if an authorized user of the mobile terminal authorizes the signing of the remote authorization object. Remote diagnosis access can thereby be authorized efficiently by the user.

According to some embodiments, the remote-diagnosis authorization object can comprise an identifier of a diagnosis authorized party, and the identifier of the diagnosis authorized party can be a unique identifier of a vehicle repair shop. The remote diagnosis authorized party can thereby be identified efficiently to the user, to the backend server of the vehicle manufacturer, and/or to the vehicle.

According to some embodiments, the identifier of the diagnosis authorized party can additionally comprise a cryptographic one-way hash for a secret known only to the diagnosis authorized party, and the remote diagnosis command can be executed on the first control unit of the vehicle and/or on one or more further control units of the vehicle only if the secret known only to the diagnosis authorized party has been verified using the cryptographic one-way hash of the remote-diagnosis authorization object by the vehicle, in particular by the first control unit of the vehicle and/or by one or more control units of the vehicle, and/or by the backend server of the vehicle manufacturer. For example, the diagnosis authorized party can transmit the secret known only to the diagnosis authorized party together with a remote diagnosis command to the first control unit and/or to one or more further control units of the vehicle. The remote diagnosis authorized party can thereby be authenticated efficiently. The security of the remote diagnosis system can thereby be further increased efficiently.

In at least one embodiment, the remote diagnosis command can be transmitted from the remote diagnosis server and/or the backend server of the vehicle manufacturer to the first control unit of the vehicle, and/or the remote diagnosis command can be transmitted together with the remote-diagnosis authorization object from the remote diagnosis server and/or the backend server of the vehicle manufacturer to the first control unit of the vehicle. The transmitting of the remote diagnosis command(s) can be improved efficiently thereby.

According to some embodiments, the identifier of the diagnosis authorized party can comprise a public key of the diagnosis authorized party, and the remote diagnosis command can be executed on the first control unit of the vehicle and/or on one or more further control units of the vehicle only if the diagnosis authorized party has cryptographically proved ownership of private key belonging to the public key of the diagnosis authorized party. The security of the execution of a remote diagnosis command can thereby be improved efficiently.

A further aspect is characterized by a computer-readable medium for operating a remote diagnosis system of a vehicle, wherein the computer-readable medium comprises instructions which, when executed on a computer and/or a control unit, perform the method described above.

Yet a further aspect is characterized by a system for operating a remote diagnosis system of a vehicle, wherein the system is designed to perform the method described above. Another aspect is characterized by a vehicle comprising the above-described system for operating a remote diagnosis system of a vehicle.

The claims, the figures and the description of the figures contain further features. All the features and combinations of features mentioned in the description above and the features and combinations of features mentioned below in the description of the figures and/or shown in the figures alone can be used not only in the respectively stated combination, but also in other combinations or alone.

The above-described features and advantages, as well as others, will become more readily apparent to those of ordinary skill in the art by reference to the following detailed description and accompanying drawings.

### BRIEF DESCRIPTION OF THE DRAWINGS

FIG. 1 shows schematically an example of a method for operating a remote diagnosis system of a vehicle; and

FIG. 2 shows schematically an example of a remote diagnosis system of a vehicle.

### DETAILED DESCRIPTION

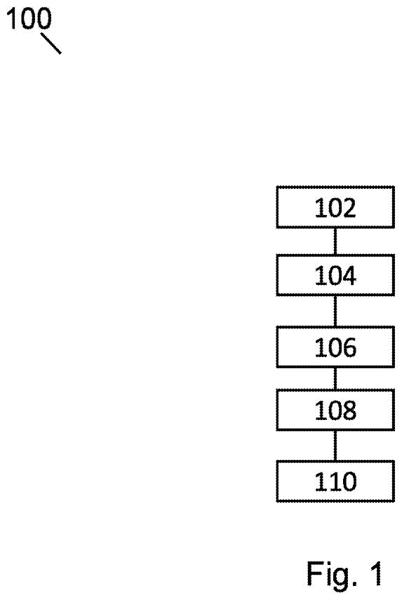

FIG. 1 shows in detail an example of a method 100 for operating a remote diagnosis system of a vehicle. The method 100 can obtain 102 a remote-diagnosis authorization object for a remote diagnosis server by a mobile terminal using a digital vehicle key. For example, the remote-diagnosis authorization object can be received from a remote diagnosis server. For example, the remote-diagnosis authorization object can be generated on the mobile terminal using the digital vehicle key for a diagnosis authorized party, for instance for the remote diagnosis server of the diagnosis authorized party.

The method 100 can sign 104 by the mobile terminal the remote-diagnosis authorization object using a private cryptographic key of the digital vehicle key. For example, the method can sign the remote-diagnosis authorization object using a digital vehicle key application of the mobile terminal. In addition, the method 100 can transmit 106 the signed remote-diagnosis authorization object from the mobile terminal to a backend server of a vehicle manufacturer and/or to a first control unit of the vehicle.

The method 100 can verify 108 on the backend server of the vehicle manufacturer and/or on the first control unit of the vehicle the signature of the signed remote-diagnosis authorization object using a public cryptographic key of the digital vehicle key. If the signature of the signed remote-diagnosis authorization object has been verified on the backend server of the vehicle manufacturer and/or on the first control unit of the vehicle using the public cryptographic key of the digital vehicle key, the method 100 can execute 110 a remote diagnosis command and/or a remote diagnosis function on the first control unit of the vehicle and/or on one or more further control units of the vehicle according to the signed remote-diagnosis authorization object.

An example of a usage scenario of the method 100 is described below. A user, for example a vehicle owner, who notices a problem with the vehicle, would like to get an independent repair shop to perform a remote diagnosis. The user is away from his vehicle, for instance at his workplace. The vehicle is parked at his home location. The remote diagnosis is meant to be performed that same day by the independent repair shop. In order to get the independent repair shop to perform remote diagnosis that same day, the user of the vehicle must grant remote diagnosis access to the independent repair shop. In this usage scenario, the method 100 can proceed as follows: the independent repair shop transmits a remote diagnosis identifier, also abbreviated below to an identifier, to the mobile terminal of the user. For example, the identifier can comprise a unique identifier of the repair shop and/or a personal character string known only to the repair shop and the user. Using a vehicle app of the mobile terminal and using the identifier, the user can specify on the mobile terminal a time interval, for instance today, and an access permission, for instance read. The vehicle app can use the identifier, the time interval and the access permission to create a remote-diagnosis authorization object. After the vehicle app has created the remote-diagnosis authorization object, the remote-diagnosis authorization object can be signed on the mobile terminal using the digital vehicle key. The signing using the digital vehicle key can comprise authentication of the user of the vehicle by the mobile terminal. For example, the mobile terminal can authenticate the user of the vehicle by a biometric feature of the user, a password, and/or a PIN. The signed remote-diagnosis authorization object can be transmitted from the mobile terminal to a remote diagnosis server of the independent repair shop. Using the signed remote-diagnosis authorization object, the independent repair shop can authenticate itself with a backend server of a vehicle manufacturer and/or with a first control unit of the vehicle. The backend server of the vehicle manufacturer and/or the first control unit of the vehicle can verify the signature of the remote-diagnosis authorization object using the public cryptographic key the digital vehicle key. If the verification is successful, the independent repair shop can perform the remote diagnosis with the vehicle.

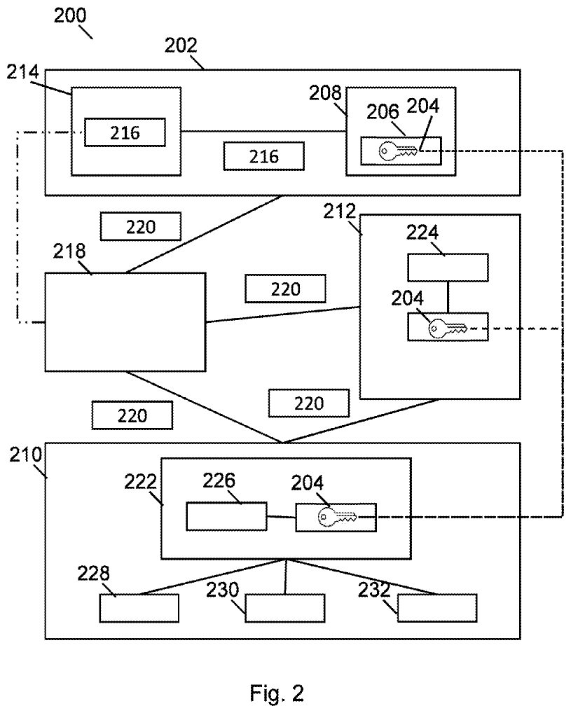

FIG. 2 shows in detail an example of a remote diagnosis system 200 of a vehicle. The remote diagnosis system 200 can comprise a mobile terminal 202 having digital vehicle key 204. The digital vehicle key 204 can be stored in a secure element 206 of the mobile terminal 202. In addition, the mobile terminal 202 can comprise a digital vehicle key application 208. The digital vehicle key 204 can be linked to a digital vehicle key 204 of a vehicle 210 and to a digital vehicle key 204 of a backend server 212 of a vehicle manufacturer. A user of the vehicle 210 can use a vehicle app 214 of the mobile terminal 202 to obtain a remote-diagnosis authorization object 216. For example, the user of the vehicle can use the vehicle app 214 to receive a remote-diagnosis authorization object 216 from a remote diagnosis server 218. To do this, the user of the vehicle app 214 can contact the remote diagnosis server 218. For example, the user of the vehicle app 214 can transmit to the remote diagnosis server 218 a message for requesting a remote diagnosis, and, in response to the message, the remote diagnosis server 218 can transmit a remote-diagnosis authorization object to the vehicle app 214. For example, the user of the vehicle app 214 can determine a remote diagnosis server 218 and/or a remote diagnosis provider by means of the vehicle app 214, and the vehicle app 214 creates the remote-diagnosis authorization object 216 for the determined remote diagnosis server 218 and/or the determined remote diagnosis provider. The user can authorize the remote-diagnosis authorization object 216 using the vehicle app 214 and the digital vehicle key application 208 by signing the remote-diagnosis authorization object 216. For the purpose of signing the remote-diagnosis authorization object 216, the vehicle app 214 can transmit the remote-diagnosis authorization object 216 to the digital vehicle key application 208.

The digital vehicle key application 208 signs the remote-diagnosis authorization object 216. The mobile terminal 202, for example the vehicle app 214 of the mobile terminal 202, can transmit the signed remote-diagnosis authorization object 220 to the remote diagnosis server 218.

The remote-diagnosis authorization object 216 and/or the signed remote-diagnosis authorization object 220 can comprise data that governs remote diagnosis access at the vehicle. For example, the remote-diagnosis authorization object 216 can comprise one or more access permissions, for instance a read permission and/or a control permission, one or more time intervals for a particular access permission or all the access permissions, for instance one day, one hour, or permanently, and/or one or more diagnosis authorized parties, for instance a vehicle manufacturer, one or more repair shops, and/or one or more remote diagnosis service providers. By signing the remote-diagnosis authorization object 216 using the digital vehicle key 204, the user can personally control and/or enable remote diagnosis access.

In order to start a remote diagnosis, the remote diagnosis server 218 can transmit the signed remote-diagnosis authorization object 220 to the backend server 212 of the vehicle manufacturer or to the first control unit 222 of the vehicle 210. The backend server 212 can comprise a software component 224 for access verification, which can verify the signature of the signed remote-diagnosis authorization object. The verification of the signature of the signed remote-diagnosis authorization object by the backend server 212 allows the vehicle manufacturer to keep a record of granted remote diagnosis access authorizations by the user. The first control unit of the vehicle 210 can comprise a software component 226 for access verification, which can verify the signature of the signed remote-diagnosis authorization object. After successful access verification by the backend server 212 and/or the first control unit, a remote diagnosis command and/or a remote diagnosis function can be executed on the first control unit 222 and/or further control units 228, 230, 232.

The method can advantageously operate a remote diagnosis system of a vehicle more efficiently. The security of the remote diagnosis system can be coupled to the security of the digital vehicle key. other words, the access protection of the remote diagnosis system is equivalent to the access protection of a digital vehicle key. The access to the vehicle using a remote-diagnosis authorization object can be associated explicitly with a digital vehicle key. If the digital vehicle key loses its validity, the remote-diagnosis authorization object can likewise lose its validity. In addition, the method allows authorized third-parties, for example independent repair shops, to perform a remote diagnosis with the vehicle. Thus in addition to the vehicle manufacturer, a multiplicity of further authorized third-parties can securely perform a remote diagnosis with the vehicle. The user of the vehicle can himself specify which access permissions shall be given to a remote diagnosis. The user of the vehicle thereby has complete control over the remote diagnosis of his vehicle. Furthermore, the user can trace transparently which remote diagnosis actions have been performed on his vehicle by a repair shop. In the event of problems with his vehicle, the user can use his mobile terminal to facilitate a remote diagnosis more quickly. Possible problems with the vehicle can hence be identified and rectified more quickly.

### LIST OF REFERENCE SIGNS

100 method
102 obtain a remote-diagnosis authorization object
104 sign the remote-diagnosis authorization object
106 transmit the signed remote-diagnosis authorization object
108 verify a signature of the signed remote-diagnosis authorization object
110 execute a remote diagnosis command
200 system
202 mobile terminal device
204 digital vehicle key
206 secure element
208 digital vehicle key application
210 vehicle
212 backend server
214 vehicle app
216 remote-diagnosis authorization object
218 remote diagnosis server
220 signed remote-diagnosis authorization object
222 first control unit
224 software component for access verification
226 software component for access verification
228 control unit
230 control unit
232 control unit

1-15. (canceled)

16. A method for operating a remote diagnosis system of a vehicle, said method comprising:
obtaining a remote-diagnosis authorization object for a remote diagnosis server by a mobile terminal using a digital vehicle key;
signing by the mobile terminal the remote-diagnosis authorization object using a private cryptographic key of the digital vehicle key;
transmitting the signed remote-diagnosis authorization object from the mobile terminal to a verification computing device, wherein the verification computing device is at least one of a backend server of a vehicle manufacturer or a first control unit of the vehicle; and
executing a remote diagnosis command on at least one control unit of the vehicle according to the signed remote-diagnosis authorization object if a signature of the signed remote-diagnosis authorization object has been verified successfully on the verification computer device using a public cryptographic key of the digital vehicle key.

17. The method as claimed in claim 16, wherein the remote-diagnosis authorization object comprises an authorization object for reading diagnostic data from the at least one control unit of the vehicle as the remote diagnosis command.

18. The method as claimed in claim 16, wherein the remote-diagnosis authorization object comprises an authorization object for controlling a remote diagnosis function of the at least one control unit of the vehicle as the remote diagnosis command.

19. The method as claimed in claim 16, wherein the private cryptographic key of the digital vehicle key is stored in a secure key memory of the mobile terminal.

20. The method as claimed in claim 16, wherein transmitting the signed remote-diagnosis authorization object from the mobile terminal to the verification computing device comprises:
transmitting the signed remote-diagnosis authorization object from the mobile terminal to the remote diagnosis server; and
transmitting the signed remote-diagnosis authorization object from the remote diagnosis server to the verification computing device.

21. The method as claimed in claim 16, wherein the remote diagnosis server is a remote diagnosis server of the vehicle manufacturer or a remote diagnosis server of a third-party.

22. The method as claimed in claim 16, wherein:
transmitting the signed remote-diagnosis authorization object from the remote diagnosis server to the backend server of the vehicle manufacturer comprises transmitting the signed remote-diagnosis authorization object from the remote diagnosis server to the backend server of the vehicle manufacturer; and
the method further comprises verifying on the backend server of the vehicle manufacturer the signature of the signed remote-diagnosis authorization object using a public cryptographic key of the digital vehicle key; and
if the signature of the signed remote-diagnosis authorization object has been verified successfully on the backend server of the vehicle manufacturer using the public cryptographic key of the digital vehicle key:
transmitting the signed remote-diagnosis authorization object from the backend server of the vehicle manufacturer to the first control unit of the vehicle.

23. The method as claimed in claim 22, said method further comprising:
if the signature of the signed remote-diagnosis authorization object has not been verified successfully on the backend server of the vehicle manufacturer using the public cryptographic key of the digital vehicle key:
transmitting an error message from the backend server of the vehicle manufacturer to the remote diagnosis server; and/or
transmitting the error message from the backend server of the vehicle manufacturer to the mobile terminal.

24. The method as claimed in claim 16, wherein the mobile terminal signs the remote-diagnosis authorization object using the private cryptographic key of the digital vehicle key if an authorized user of the mobile terminal authorizes the signing of the remote authorization object.

25. The method as claimed in claim 16, wherein the remote-diagnosis authorization object includes an identifier of a diagnosis authorized party; and
wherein the identifier of the diagnosis authorized party is a unique identifier of a vehicle repair shop.

26. The method as claimed in claim 25, wherein the identifier of the diagnosis authorized party comprises a public key of the diagnosis authorized party; and
wherein the remote diagnosis command is executed on the at least one control unit of the vehicle only if the diagnosis authorized party has cryptographically proved ownership of a private key belonging to the public key of the diagnosis authorized party.

27. The method as claimed in claim 25, wherein the identifier of the diagnosis authorized party additionally comprises a cryptographic one-way hash for a secret known only to the diagnosis authorized party; and
wherein the remote diagnosis command is executed on the at least one control unit of the vehicle only if the secret known only to the diagnosis authorized party has been verified using the cryptographic one-way hash of the remote-diagnosis authorization object by the verification computing device.

28. The method as claimed in claim 16, wherein the remote diagnosis command is transmitted from the remote diagnosis server or the backend server of the vehicle manufacturer to the first control unit of the vehicle;
wherein the remote diagnosis command is transmitted together with the remote-diagnosis authorization object to the first control unit of the vehicle.

29. A system for operating a remote diagnosis system of a vehicle, wherein the system is designed to perform the method as claimed in claim 16.

30. A method for operating a remote diagnosis system of a vehicle, said method comprising:
obtaining a signed remote-diagnosis authorization object at a remote diagnosis server from a mobile terminal, wherein the mobile terminal has signed the remote-diagnosis authorization object using a private cryptographic key of a digital vehicle key;
transmitting the signed remote-diagnosis authorization object from the remote diagnosis server to a verification computing device, wherein the verification computing device is at least one of a backend server of a vehicle manufacturer or a first control unit of the vehicle; and
executing a remote diagnosis command on at least one control unit of the vehicle according to the signed remote-diagnosis authorization object if a signature of the signed remote-diagnosis authorization object has been verified successfully on the verification computing device using a public cryptographic key of the digital vehicle key.

31. The method as claimed in claim 30, wherein the remote-diagnosis authorization object comprises an authorization object for reading diagnostic data from the at least one control unit of the vehicle as the remote diagnosis command.

32. The method as claimed in claim 30, wherein the remote-diagnosis authorization object comprises an authorization object for controlling a remote diagnosis function of the at least one control unit of the vehicle as the remote diagnosis command.

33. A computer-readable medium for operating a remote diagnosis system of a vehicle, wherein the computer-readable medium comprises instructions which, when executed on a computer and/or a control unit, perform the method as claimed in claim 30.
